(19) United States
(12) Patent Application Publication
(10) Pub. No.: US 2009/0311558 A1
(43) Pub. Date: Dec. 17, 2009

(54) MAGNETIC RECORDING MEDIUM AND MANUFACTURING METHOD

(75) Inventor: Hiroto Takeshita, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/408,604

(22) Filed: Mar. 20, 2009

(30) Foreign Application Priority Data
Jun. 13, 2008 (JP) 2008-155390

(51) Int. Cl. G11B 5/62; B05D 5/12; B44C 1/22

(52) U.S. Cl. 428/848.5; 427/128; 216/22

(57) ABSTRACT

A magnetic recording medium that includes: a disc-shaped substrate; and plural magnetization retainers arranged on the disc-shaped substrate in plural circulations around a center of the substrate, each of the magnetization retainers having a length in a circumferential direction in such a manner that the length becomes longer as closer to outer circumference at least in a predetermined area, each retaining magnetization individually, each being formed of a magnetic material having axis of easy magnetization of magnetocrystalline anisotropy in a direction perpendicular to front and back surfaces of the substrate, each being filled with an ion that weakens the magnetocrystalline anisotropy of the magnetic material such that an amount of ion implantation becomes less as closer to the outer circumference in the predetermined area.

### CROSS-REFERENCE TO RELATED APPLICATION

This application is based upon and claims the benefit of priority of the prior Japanese Patent Application No. 2008-155390, filed on Jun. 13, 2008, the entire contents of which are incorporated herein by reference.

### FIELD

The embodiments discussed herein are related to a magnetic recording medium in which information is recorded by a direction of magnetization, and a manufacturing method of the magnetic recording medium.

### BACKGROUND

In the field of computer, a large amount of information is handled everyday, and a Hard Disk Drive (HDD) is used as one of devices for recording and reproducing massive information. The HDD internally includes a magnetic disk that is a disc-shaped magnetic recording medium into which information is recorded. As a magnetic disk, there is conventionally known a magnetic disk of continuous media in which a continuous magnetic layer is formed on a disk made of a nonmagnetic material. In this type of magnetic disk, information is recorded in a magnetic domain made of clusters of crystal grains composing a magnetic layer by a direction of magnetization generated in each crystal grain. The magnetic domain can be formed at any location on the magnetic disk by a magnetic head.

Here, there is a phenomenon called thermal fluctuation as one of phenomena that hinders a long-term storage of information recorded in the magnetic disk. The thermal fluctuation makes a direction of magnetization in magnetic particles unstable due to the effect of external thermal energy, and this phenomenon occurs more noticeably in finer magnetic particles. In recent years, ever-higher recording density has been promoted in the field of magnetic disk, which facilitates finer crystal grains composing magnetic layers, and thus thermal fluctuation has become a big issue.

A so-called perpendicular magnetic recording is conventionally known as a recording method that is robust against the thermal fluctuation and is a main technology today in the field of HDD. In the perpendicular magnetic recording, information is recorded by directing magnetization in each magnetic domain in a direction perpendicular to the front and back surfaces of the magnetic disk. However, demands of high recording density for the magnetic disks are ever increasing, and if a crystal grain is made further finer to achieve ever-higher recording density, then coping with the thermal fluctuation becomes difficult even by the perpendicular magnetic recording.

Therefore, as an example of magnetic disks having further higher recording density and tolerance for the thermal fluctuation, a type of magnet disks called as patterned media (described later) is proposed (for example, see Japanese Patent No. 1888363).

A magnet disk of patterned media includes a micro magnetic material (dot) aligned at a fixed position on the magnetic disk. Each dot is a formed crystal grain or a formed cluster of multiple crystal grains that are strongly magnetically coupled together to magnetically behave like a single crystal grain. Each dot retains one magnetization and stores a smallest unit of information. Inmost of the magnetic disks of patterned media, each dot has magnetic anisotropy having axis of easy magnetization in a direction perpendicular to the front and back surfaces of the magnetic disk, and information is recorded by the perpendicular magnetic recording.

In the magnetic disk of patterned media, a dot into which the smallest unit of information is recorded is a single crystal grain itself or one that behaves like a single crystal grain. Hence, it is possible to make the size of the crystal grain that affects tolerance for the thermal fluctuation larger in the magnetic disk of patterned media than in the magnetic disk of continuous media, while achieving high recording density by a finer dot. In general, the magnetic disk of patterned media can realize almost the same degree of recording density as the magnetic disk of continuous media has, by a crystal grain that is several times or several tens of times larger than a crystal grain in the magnetic disk of continuous media, and thus attain very strong tolerance for the thermal fluctuation.

Incidentally, in typical HDD, recording and/or reproducing of information are performed in a state where the magnetic disk rotates at a constant speed. At this time, in the magnetic disk that is in a state of rotating, circumferential speed becomes larger on its outer circumference than on its inner circumference. Here, it is desirable for the magnetic disk in the state of rotating to take equal time for recording and/or reproducing information to/from each dot both on the inner and outer circumferences. In the magnetic disk of patterned media, it is conventionally practiced to make a length in a circumferential direction of the dot (dot length) longer as closer to the outer circumference of the magnetic disk, so that desirable recording and reproducing can be realized by absorbing differences in the circumferential speed. For example, in such a magnetic disk, a ratio of dot length on the outermost circumference to dot length on the innermost circumference is about two times for a magnetic disk of 2.5-inch diameter, and the ratio is about three times for a magnetic disk of 3.5-inch diameter.

Here, in the magnetic disk of patterned media, magnetization switching field that is a magnetic field required to switch magnetization in each dot is an important parameter to determine the accuracy of information recording in the magnetic disk. To achieve information recording in all dots in the magnetic disk with high accuracy, it is desirable for the dots in the magnetic disk to have an uniform magnetization switching field. However, generally in the magnetic disk in which the dot length is longer as closer to the outer circumference, it is known that the magnetization switching field in the dots does not become uniform.

This is because the magnetization switching field in the dots is based on both the above-described magnetic anisotropy (magnetocrystalline anisotropy) due to a crystal structure of the crystal grains composing the dots and an after-mentioned magnetic anisotropy (magnetic shape anisotropy) due to a shape of the dots.

For example, in a dot that is shaped to have a longitudinal direction such as a rectangular shape, magnetization in the dot tends to be directed to the longitudinal direction than to the shortest direction, and the dot has magnetic shape anisotropy having axis of easy magnetization in the longitudinal direction of the dot.

In general, since the magnetocrystalline anisotropy is higher than the magnetic shape anisotropy, basically the magnetization in the dot is directed to the perpendicular direction. Furthermore, due to the magnetic shape anisotropy, the magnetization is in a state of being easily switched to the circumferential direction in which the magnetization rotates to the longitudinal side of the dot. Moreover, since the magnetic shape anisotropy becomes larger as the dot becomes longer in the longitudinal direction, the magnetization is switched more easily as the dot becomes longer in the longitudinal direction. That is, the magnetization switching field in the dot is lowered as the dot becomes longer in the longitudinal direction.

As described above, in the magnetic disk in which the dot length becomes longer as closer to the outer circumference, the magnetic shape anisotropy having the axis of easy magnetization in the circumferential direction becomes larger in accordance with change in the dot length and as a result, the magnetization switching field decreases.

FIG. 13 is a graph illustrating how the magnetization switching field decreases in accordance with change in the dot length.

A graph G21 in FIG. 13 is a simulation of change in the magnetization switching field when the dot length is changed from “10 nm” to “40 nm” for a dot having a dot thickness (dot thickness) of “10 nm” and a dot width in radius direction of the magnetic disk (dot width) of “10 nm”. In the example of FIG. 13, the intensity of magnetocrystalline anisotropy of the dot and a saturation magnetization of the dot are given as parameters in the simulation. In general, the intensity of the magnetocrystalline anisotropy or the magnetic shape anisotropy is represented as the intensity of magnetic field (magnetocrystalline anisotropy field, magnetic shape anisotropy field) required to direct the magnetization in a direction perpendicular to the axis of easy magnetization in each anisotropy. In the example of FIG. 3, “10 kOe (795.77 kA/m)” is given as the intensity of a magnetocrystalline anisotropy field Hk of the dot, and “1000 emu (1 MA/m)” is given as a saturation magnetization Ms of the dot.

In the graph G21 of FIG. 13, its horizontal line represents the dot length and its vertical line represents the magnetization switching field. A line L21 indicates change in the magnetization switching field with respect to change in the dot length. As apparent from the line L21 in the graph G21, in the example of FIG. 13, the magnetization switching field drops as much as 40% or more as the dot length becomes longer from “10 nm” to “30 nm”.

Therefore, as described above, in order to keep the time required for recording and reproducing constant for the respective dots, in the magnetic disk in which the dot length becomes longer as closer to the outer circumference, the magnetization switching field of the dots is not uniform, and the magnetization switching field of the dot decreases more as closer to the outer circumference.

As a result, if the intensity of a head magnetic field applied by the magnetic head is determined based on the magnetization switching field for a dot on the inner circumference, there is a possibility that at the time of recording information in a dot on the outer circumference, the head magnetic field is so high that a write error is caused to overwrite information in another dot adjacent to the dot of recording target. Or, if the intensity of the head magnetic field is determined based on the magnetization switching field of a dot on the outer circumference, there is a possibility that at the time of recording information on the inner circumference, the intensity of the head magnetic field is so low that a write error is caused to fail to record information.

Therefore, in order to suppress the generation of write errors due to heterogeneous magnetization switching field, the following techniques have been proposed.

For instance, a technology is proposed to suppress the generation of write errors by controlling the magnetic shape anisotropy of the dot itself with an idea regarding the shape of the dot, such as making the dot length and the dot width substantially equal to each other, or with an idea regarding selection of materials, such as forming the dot with a magnetic material having small saturation magnetization Ms that is a parameter for determining the intensity of the magnetic shape anisotropy (See Japanese Patent No. 1888363, for example).

There is also proposed a technology for suppressing the generation of write errors by matching the magnetization switching field of each dot to the intensity of the head magnetic field. This is achieved by supplying a current of which intensity is dependent on a position of each dot in the radius direction of the magnetic disk, to a magnetic head that receives the current and applies a head magnetic field of which intensity is dependent on the intensity of the current (See Japanese Patent No. 4006400, for example).

However, in the technologies of suppressing the magnetic shape anisotropy of the dot itself by contriving the shape of the dot or the selection of material, there is a problem that flexibility is reduced in designing the magnetic disk. Also, in the technique of matching the magnetization switching field of each dot to the intensity of the head magnetic field by adjusting the intensity of current supply to the magnetic head, there is a problem that an additional control system is required to adjust the intensity of current supply, thereby complicating control system of information recording device such as HDD.

Here, there is a type of magnetic disks of which surface is concentrically divided into multiple areas (zones). In this type of magnetic disks, it is possible to make the time necessary to record/reproduce to/from a dot in one zone and the time necessary to record/reproduce to/from a dot in another zone substantially equal, for example, by making a rotating speed of the magnetic disks or a recording/reproducing speed to/from the dot dependent on a distance of each zone from the center of the disk. However, in each zone, a difference in circumferential speed is still generated between the inner circumference and the outer circumference. Thereby, for the purpose of absorbing the difference in the circumferential speed, it may be possible to make the length in the circumferential direction longer as closer to the outer circumference. As a result, in the magnetic disks having a zone structure, the above-described problem that the magnetization switching field is heterogeneous in each zone arises.

In the above, no explanation is made for a range where the magnetization switching field becomes heterogeneous in the magnetic disks. However, in the magnetic disks having the zone structure, this problem occurs in each zone as described above, and in the magnetic disks without the zone structure, this problem occurs in all areas ranging from the innermost to outermost circumferences.

### SUMMARY

According to an aspect of the invention, a magnetic recording medium includes a disc-shaped substrate; and plural magnetization retainers arranged on the disc-shaped substrate in plural circulations around a center of the substrate, each of the magnetization retainers having a length in a circumferential direction in such a manner that the length becomes longer as closer to outer circumference at least in a predetermined area, each retaining magnetization individually, each being formed of a magnetic material having axis of easy magnetization of magnetocrystalline anisotropy in a direction perpendicular to front and back surfaces of the substrate, each being implanted with an ion that weakens the magnetocrystalline anisotropy of the magnetic material in such a manner that an amount of ion implantation becomes less as closer to the outer circumference in the predetermined area.

According to another aspect of the invention, a manufacturing method of a magnetic recording medium includes the steps of:

forming on a disc-shaped substrate, a magnetic film made of a magnetic material and having axis of easy magnetization of magnetocrystalline anisotropy in a direction perpendicular to front and back surfaces of the substrate;

forming plural magnetization retainers each retaining magnetization individually, each being arranged on the substrate in plural circulations around a center of the substrate by leaving magnetization retained in the magnetic film locally while destroying magnetization in another portions, each having a length in a circumferential direction such that the length becomes longer as closer to outer circumference at least in a predetermined area; and

implanting an ion to weaken the magnetocrystalline anisotropy of the magnetic material with an amount of ion implantation that becomes less as closer to the outer circumference in the predetermined area, which is performed before or after the step of forming plural magnetization retainers.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A and FIG. 1B are drawings of a magnetic disk of patterned media as an embodiment of the magnetic recording medium;

FIG. 2 schematically illustrates the magnetic disk of FIG. 1, in which a dot length of each dot becomes longer as closer to the outer circumference of the disk;

FIG. 3 illustrates that the magnetization switching field is maintained uniform by making the magnetic shape anisotropy larger as the dot length becomes longer;

FIG. 4 illustrates that an amount of ion implantation in the dots is reduced more as closer to the outer circumference in the magnetic disk of FIG. 1, thereby the magnetic shape anisotropy becomes larger as closer to the outer circumference;

FIG. 5 illustrates a flow of a first manufacturing method of a magnetic disk to produce the magnetic disk explained with reference to FIGS. 1 to 4;

FIG. 6 is a detailed drawing of the processing of ion implantation using argon ion;

FIG. 7 illustrates a flow of a second manufacturing method of a magnetic disk to produce the magnetic disk explained with reference to FIGS. 1 to 4;

FIG. 8 is a drawing of a magnetic disk of patterned media as an embodiment of the magnetic recording medium;

FIG. 9 illustrates a flow of the first manufacturing method to produce the magnetic disk explained with reference to FIG. 8;

FIG. 10 illustrates a method of forming a filter film in step S32 of FIG. 9;

FIG. 11 is a graph indicating a relationship between a lattice interval and a deposition speed of sputter particles;

FIG. 12 illustrates a flow of the second manufacturing method to produce the magnetic disk explained with reference to FIG. 8; and

FIG. 13 is a graph indicating how the magnetization switching field drops in accordance with change in the dot length.

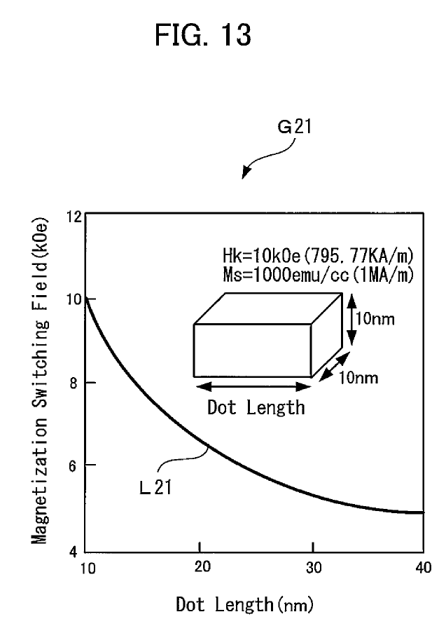

### DESCRIPTION OF EMBODIMENTS

Hereinafter, specific application mode will be described with reference to drawings, in contrast to the basic mode of the magnetic recording medium and the manufacturing method of the magnetic recording medium explained in SUMMARY.

A first embodiment will be described below, in contrast to the basic mode of the magnetic recording medium and the manufacturing method of the magnetic recording medium.

In the first embodiment, explanation is made for a magnetic disk of patterned media as an embodiment of the magnetic recording medium and two types of manufacturing methods of the magnetic disk each of which is an embodiment of the manufacturing method of the magnetic recording medium.

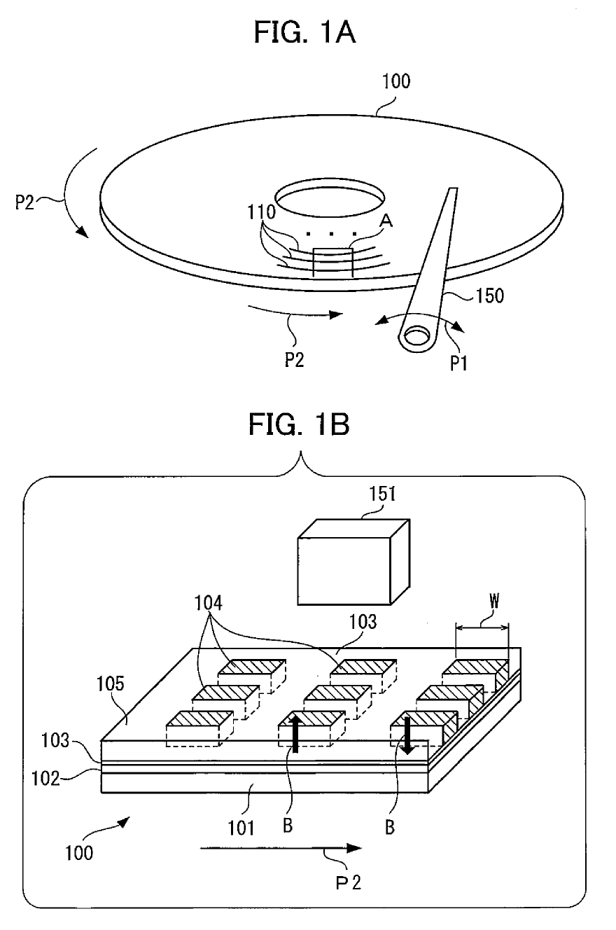

FIG. 1A and FIG. 1B are drawings of a magnetic disk of patterned media as an embodiment of the magnetic recording medium.

FIG. 1A illustrates a magnetic disk 100 of patterned media in which information is recorded by the perpendicular magnetic recording and a head gimbal assembly 150 that mounts on its tip a magnetic head 151 (see FIG. 1B) for recording and reproducing information to and from the magnetic disk 100. FIG. 1B is an enlarged view of an area A in the magnetic disk 100 of FIG. 1A.

As illustrated in FIG. 1B, the magnetic disk 100 of patterned media includes a disc-shaped substrate 101 made of a nonmagnetic material and plural fine magnetic elements (dots) 104 each individually retains magnetization and is aligned on a two-layered film formed on the disc-shaped substrate 101. The two-layered film is composed of a backing layer 102 made of a magnetic material and an intermediate layer 103 made of a nonmagnetic material.

The disc-shaped substrate 101 is an example of the substrate in the basic mode and the dots 104 are an example of the magnetization retainer in the basic mode.

In contrast to the basic mode of the magnetic recording medium and the manufacturing method thereof, an application mode that “the magnetization retainer is formed of a magnetic material containing cobalt and platinum” is a typical mode.

A magnetic material containing cobalt and platinum is a material having good magnetization and generally used as magnetic materials for recording information in the magnetic disks.

Also in this embodiment, the dots 104 are formed of an alloy containing cobalt and platinum. That is, the dots 104 also correspond to an example of the magnetization retainer in the application mode.

Further in this embodiment, the perpendicular magnetic recording is employed so that each of the dots 104 retains magnetic anisotropy (magnetocrystalline anisotropy) having the axis of easy magnetization in a direction perpendicular to the front and back surfaces of the magnetic disk 100, by utilizing a crystal structure in the alloy. Thereby, the respective dots 104 retain magnetization in the direction perpendicular to the front and back surfaces of the magnetic disk 100 like a magnetization B illustrated in FIG. 1B.

In the magnetic disk 100, these plural dots 104 are arranged on the two-layered film in plural circulations in a manner of circulating around the center of the disk concentrically, thereby forming multiple tracks 110 as illustrated in FIG. 1A. Further in this embodiment, each of the dot 104 has a rectangular shape extending in a circumferential direction of the track 110 to which each of the dots 104 belongs. A gap between the respective dots 104 is filled with a nonmagnetic gap section 105. In this embodiment, the dots 104 and the gap section 105 are formed such that magnetization of a uniform magnetic film formed on the intermediate layer 103 is partially left in portions for the dots 104 and the magnetization in another portion is destroyed by ion implantation using argon ion.

When information is recorded and/or reproduced in and/or from the magnetic disk 100, the head gimbal assembly 150 moves rotationally in a direction indicated by an arrow P1 in FIG. 1A to perform tracking, and the magnetic head 151 mounted on the tip is positioned on the target track 110. In this state, when the magnetic disk 100 rotates in a direction indicated by an arrow P2, the respective dots 104 belonging to the target track 110 sequentially pass below the magnetic head 151. The magnetic head 151 reproduces information by detecting a direction of magnetization in the dot 104 passing right below the magnetic head 151. The magnetic head 151 records information by applying magnetic field to the dot 104 passing right below the magnetic head 151 to direct magnetization in the dot 104 toward a direction in accordance with the direction of the magnetic field.

FIG. 1B illustrates the dots 104 aligned in three tracks 110 adjoining to one another and the magnetic head 151 placed above the central track 110 among the three tracks 110, as a target of reproducing or recording information.

In FIG. 1B, to simplify the drawing, a length in the circumferential direction of the dots 104 (dot length) W each belonging to the different tracks 110 is illustrated in an equal length. However, in this embodiment, the dot length W of each dot 104 actually becomes longer as closer to the outer circumference.

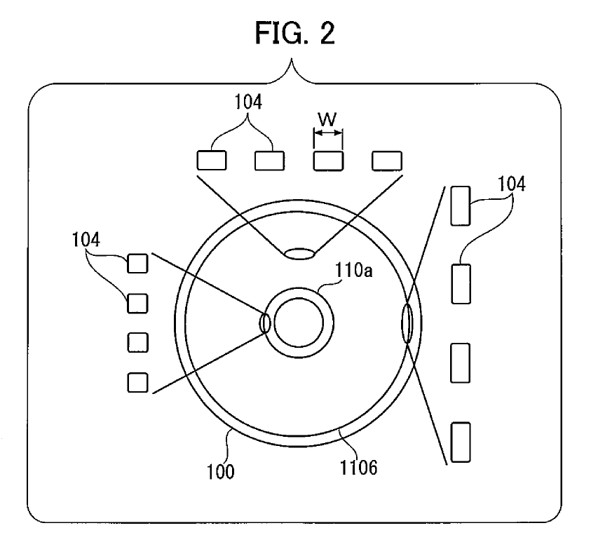

FIG. 2 schematically illustrates the magnetic disk of FIG. 1, in which a dot length of each dot becomes longer as closer to the outer circumference of the magnetic disk.

As illustrated in FIG. 2, in this embodiment, in all areas from an innermost track 110a to an outermost track 110b, the dot length W of the respective dots 104 becomes longer as closer to the outer circumference.

At the time of recording and/or reproducing in/from the magnetic disk 100, differences in circumferential speed are generated among the different tracks 110 in the rotating magnetic disk 100. Namely, a circumferential speed of the track 110 on the outer circumference becomes larger than that of the track 110 on the inner circumference. Here, it is desirable for the magnetic disk 100 in the state of rotating to have an equal recording or reproducing time in the respective dots 104 both on the inner and outer circumferences. In the magnetic disk 100 in this embodiment, for the purpose of realizing a desirable recording and reproducing by absorbing the differences in the circumferential speed in all areas from the innermost track 110a to the outermost track 110b, the dot length W of the respective dots 104 is made longer as closer to the outer circumference in all the areas.

On the other hand, in the magnetic disk 100, since the dot length W of the respective dots 104 becomes longer as closer to the outer circumference, magnetic shape anisotropy of the respective dots 104 having the axis of easy magnetization in the circumferential direction becomes larger as closer to the outer circumference in all areas from the innermost track 110a to the outermost track 110b.

At this point, in the magnetic disk 100, in the respective dots 104, an influence to lower the magnetization switching field required for switching the magnetization in the respective dots 104 is generated due to the magnetic shape anisotropy. Since in the magnetic disk 100, the magnetic shape anisotropy becomes larger as closer to the outer circumference, the influence to lower the magnetization switching field becomes larger on the outer circumference.

In order to cancel the influence to lower the magnetization switching field in the respective dots 104, which becomes larger on the outer circumference than the inner circumference and to maintain the magnetization switching field uniform in all the areas, in this embodiment, in the respective dots 104, the magnetocrystalline anisotropy having the axis of easy magnetization in the direction perpendicular to the magnetic disk 100 is made larger as closer to the outer circumference, that is, the longer the dot length becomes, the larger the magnetocrystalline anisotropy is made.

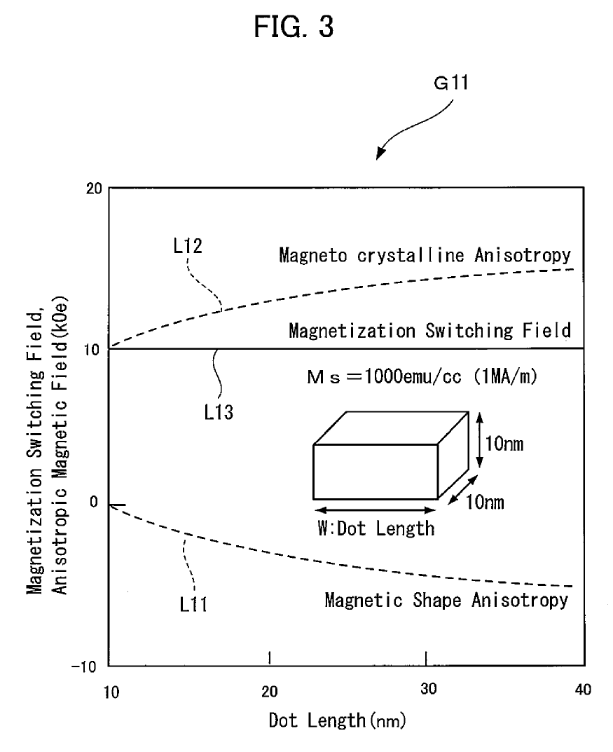

FIG. 3 illustrates a state in which the magnetization switching field is maintained uniformly by making the magnetocrystalline anisotropy larger as the dot length becomes longer.

FIG. 3 illustrates a graph G11 that indicates change in the magnetic shape anisotropy, change in the magnetocrystalline anisotropy, and change in the magnetization switching field when the dot length W is continuously changed from “10 nm” to “40 nm” for a dot having the thickness (dot thickness) of “10 nm”, the width in radius direction of the magnetic disk (dot width) of “10 nm”, and the saturation magnetization Ms of “1000 emu (1 MA/m)”. In the graph G11 of FIG. 3, its horizontal axis indicates the dot length W and its vertical axis indicates the anisotropy field and the magnetization switching field each representing the above-described two types of magnetic anisotropy. Additionally, in this graph G11, a direction that increases the magnetization switching field is defined positive on the vertical axis. Since the increase in the magnetic shape anisotropy results in the decrease in the magnetization switching field, therefore in this graph G11, the magnetic shape anisotropy is indicated as negative anisotropic magnetic field, whereas the magnetocrystalline anisotropy is indicated as positive anisotropic magnetic field since the increase in the magnetocrystalline anisotropy results in the increase in the magnetization switching field.

In the graph G11 of FIG. 3, a first line L11 representing change in the magnetic shape anisotropy is indicated by a doted line. As the first line L11 indicates, if the dot length W becomes longer, the magnetic shape anisotropy increases in the negative direction, that is, the magnetic shape anisotropy increases in the direction to lower the magnetization switching field.

Also in the graph G11 of FIG. 3, a second line L12 representing change in the magnetocrystalline anisotropy is indicated by a doted line. As the line L12 indicates, as the dot length W becomes longer, if the magnetocrystalline anisotropy is increased in the positive direction by an amount that is equal to the increase in the negative direction of the magnetic shape anisotropy, the decrease in the magnetization switching field caused by the increase of the magnetic shape anisotropy caused by the increase in the magnetic shape anisotropy is cancelled by the increase in the magnetization switching field caused by the increase in the magnetocrystalline anisotropy.

The graph G11 of FIG. 3 indicates by a solid line (a third line L13) that the decrease in the magnetization switching field caused by the increase in the magnetic shape anisotropy as the dot length W that becomes longer is cancelled by the increase in the magnetization switching field caused by the increase in the magnetocrystalline anisotropy and that the magnetization switching field is maintained constant against the change in the dot length W.

In this embodiment, the magnetocrystalline anisotropy that becomes larger as the dot length becomes longer, namely, becoming larger as closer to the outer circumference of the magnetic disk 100 to maintain the magnetization switching field constant against the change in the dot length W is realized as follows.

Generally, it is possible to weaken the magnetocrystalline anisotropy in a magnetic material by disturbing its crystal structure by ion implantation using such as argon ion. In this embodiment, by utilizing the effect of reduction in the magnetocrystalline anisotropy by the ion implantation using argon ion, the magnetocrystalline anisotropy that becomes larger as closer to the outer circumference is realized. That is, in this embodiment, the ion implantation with argon ion is performed such that an amount of ion implantation is reduced gradually as closer to the outer circumference in all areas from the innermost to outermost circumferences, thereby making the magnetocrystalline anisotropy of the dot larger as closer to the outer circumference.

Here, an application mode that “the magnetization retainer is implanted with at least one type of ions selected from argon ion, oxygen ion, or nitrogen ion as the ion” is preferable to the basic mode.

Either of argon ion, oxygen ion, and nitrogen ion can reduce the magnetocrystalline anisotropy adequately by disturbing crystal structures of the above-described magnetic materials.

In this embodiment, the dot 104 which is subjected to ion implantation with argon ion as described above corresponds to an example of the application mode.

Further, the magnetic disk 100 in this embodiment is a simple type of magnetic disk which does not have the so-called zone structure and is rotated at a constant rotating speed when information is recorded or reproduced. Therefore, its circumferential speed becomes larger on the outer track 110 than on the inner track 110 in all areas from the innermost to outermost circumferences. As a result, for the purpose of making recording or reproducing time in the respective dots 104 uniform, the dot length is made longer as closer to the outer circumference in all areas, thereby the magnetic shape anisotropy caused by differences in the dot length is made larger as closer to the outer circumference in the all areas. And the heterogeneity in the magnetization switching field due to the heterogeneous magnetic shape anisotropy is cancelled by performing the ion implantation in such a manner that the amount of ion implantation becomes less as closer to the outer circumference in all the areas to make the magnetocrystalline larger.

Here, an application mode that “the length in the circumferential direction of the plural magnetization retainers becomes longer as closer to the outer circumference and the amount of the ion implantation becomes less as closer to the outer circumference in all areas from the innermost to outermost circumferences” is also preferable to the basic mode.

In this application mode, the heterogeneity in the magnetization switching field is suppressed for a simple type magnetic recording medium without the zone structure, and the dots 104 in this embodiment correspond to an example of the magnetization retainer in the application mode. In this application mode, there is no need to adjust rotating speed of the magnetic recording medium (magnetic disk) or recording/reproducing speed in/from the dots, which adjustment is specific in the zone structure, there by enabling even easier recording and reproducing of information.

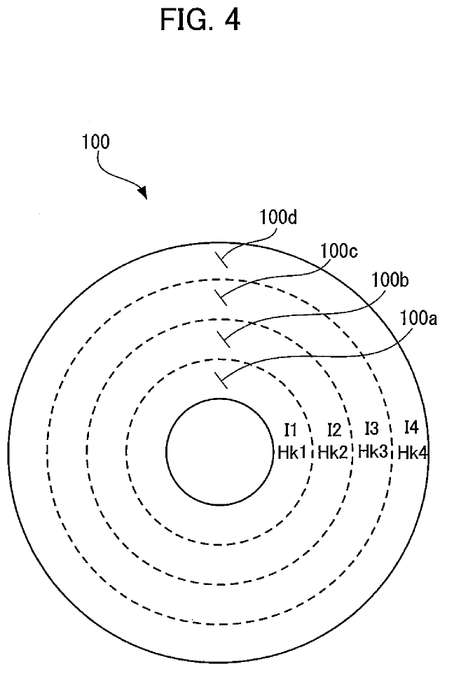

FIG. 4 illustrates a state in which the amount of ion implantation in the dots on the outer circumference becomes less in the magnetic disk of FIG. 1 to make the magnetocrystalline anisotropy larger as closer to the outer circumference.

As illustrated in FIG. 4, the magnetic disk 100 in this embodiment is divided into four areas of a first area 100a, a second area 100b, a third area 100c, and a fourth area 100d from the inner circumference. And the amount of ion implanted into dots in each area becomes less in the order of an ion implantation amount I1 in the first area 100a, an ion implantation amount I2 in the second area 100b, an ion implantation amount I3 in the third area 100c, and an ion implantation amount I4 in the fourth area 100d. As a result, in accordance with the ion implantation amount in each area, the magnetocrystalline anisotropy field that represents the intensity of the magnetocrystalline anisotropy in the dots 104 in each area becomes larger in the order of a magnetocrystalline anisotropy field Hk1 in the first area 100a, a magnetocrystalline anisotropy field Hk2 in the second area 100b, a magnetocrystalline anisotropy field Hk3 in the third area 100c, and a magnetocrystalline anisotropy field Hk4 in the fourth area 100d from the inner circumference.

Further, in this embodiment, the ion implantation amount I4 in the fourth area 100d that is the outermost circumference area is “0”. And the magnetocrystalline anisotropy field Hk4 in the fourth area 100d, that is, a default magnetocrystalline field with the ion implantation amount I4 of “0” is the magnetocrystalline anisotropy field associated with an average of the dot lengths in the fourth area 100d on the second line L12 in the graph G11 of FIG. 3.

The magnetocrystalline anisotropy field Hk1 in the first area 100a is the magnetocrystalline anisotropy field associated with an average of the dot lengths in the first area 100a on the second line L2 in the graph G11 of FIG. 3, and the ion implantation amount I1 in the first area 100a is the ion implantation amount required to lower the default magnetocrystalline anisotropy field Hk4 to the magnetocrystalline anisotropy field Hk1 in the first area 100a obtained from the graph G11.

Similarly, the magnetocrystalline anisotropy fields Hk2, Hk3 in the second and the third areas are the magnetocrystalline anisotropy fields respectively associated with an average of the dot lengths in each area on the second line L12 in the graph G11 of FIG. 3, and the ion implantation amounts I2, I3 in the respective areas are the ion implantation amounts required to lower the default magnetocrystalline anisotropy field Hk4 to the magnetocrystalline anisotropy fields Hk2, Hk3 in the respective areas obtained from the graph G11.

As a result, in the magnetic disk 100 in this embodiment, in all areas from the innermost to outermost circumferences, the magnetization switching field of the dots is substantially uniform at “10 kOe (795.77 kA/m)”, although there are slight fluctuations, as indicated on the third line L13 in the graph G11 of FIG. 3.

Thereby, according to the magnetic disk 100, switching of magnetization is enabled for the respective dots in all areas by magnetic field of the same intensity, and information can be easily recorded with high accuracy by suppressing the generation of write errors. Also in the magnetic disk 100, uniformity in the magnetization switching field is realized by the ion implantation. Thereby, no restriction is imposed on the type of magnetic disks such as the magnetic disk 100 in shaping the dot itself or in selecting magnetic materials to form the dot, allowing high flexibility in designing.

Next, explanation will be made for a first manufacturing method of a magnetic disk to produce the magnetic disk 100 explained by referring to FIGS. 1 to 4. The first manufacturing method of a magnetic disk corresponds to an embodiment of the manufacturing method of a magnetic recording medium.

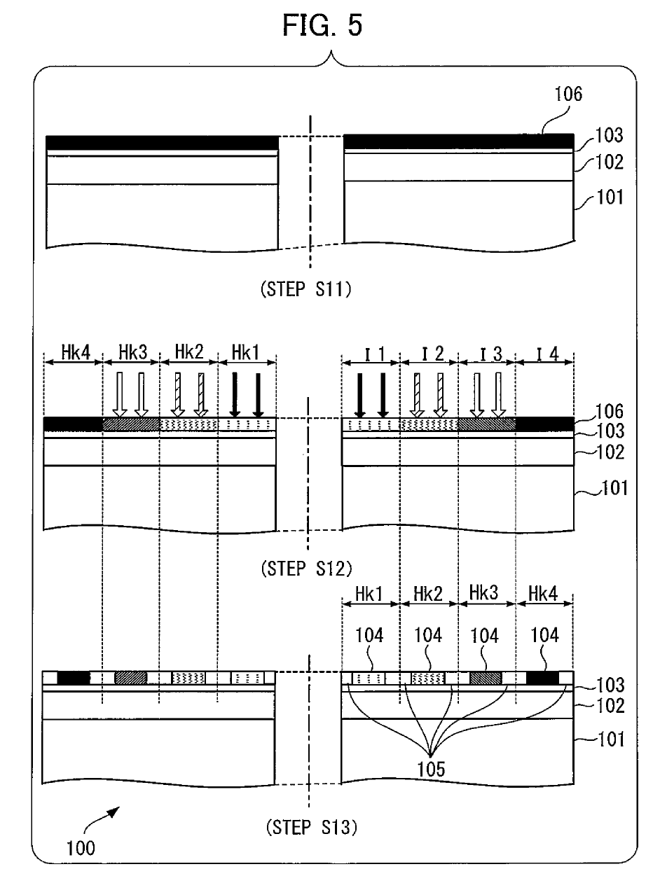

FIG. 5 illustrates a flow of the first manufacturing method of a magnetic disk to produce the magnetic disk 100 explained with reference to FIGS. 1 to 4.

In the first manufacturing method of a magnetic disk illustrated in FIG. 5, firstly, on a disc-shaped substrate 101 of a nonmagnetic material, a three-layered film composed of the backing layer 102 made of a predetermined magnetic material, the intermediate layer 103 made of a nonmagnetic material, and a magnetic film 106 is formed by sputtering method (step S11). The magnetic film 106 that becomes a source of the dots 104 as described later is formed of an alloy containing cobalt and platinum capable of reducing magnetocrystalline anisotropy thereof by ion implantation, and has the axis of easy magnetization in a direction perpendicular to the disc-shaped substrate 101. Accordingly, in this embodiment, the magnetocrystalline anisotropy of the magnetic film 106 is the magnetocrystalline anisotropy associated with the average dot length in the fourth area 100d on the second line L12 in the graph G11 of FIG. 3. The processing in this step S11 corresponds to an example in the step of forming a magnetic film in the basic mode.

Secondly, ion implantation with argon ion is performed to the magnetic film 106 (step S12). In this step S12, the ion implantation with argon ion is performed to each of the four areas 100a, 100b, 100c, and 100d in the magnetic film 106, with the four types of amounts of ion implantation, I1, I2, I3, and I4 as described later. The processing in this step S12 corresponds to an example in the step of implanting an ion in the basic mode.

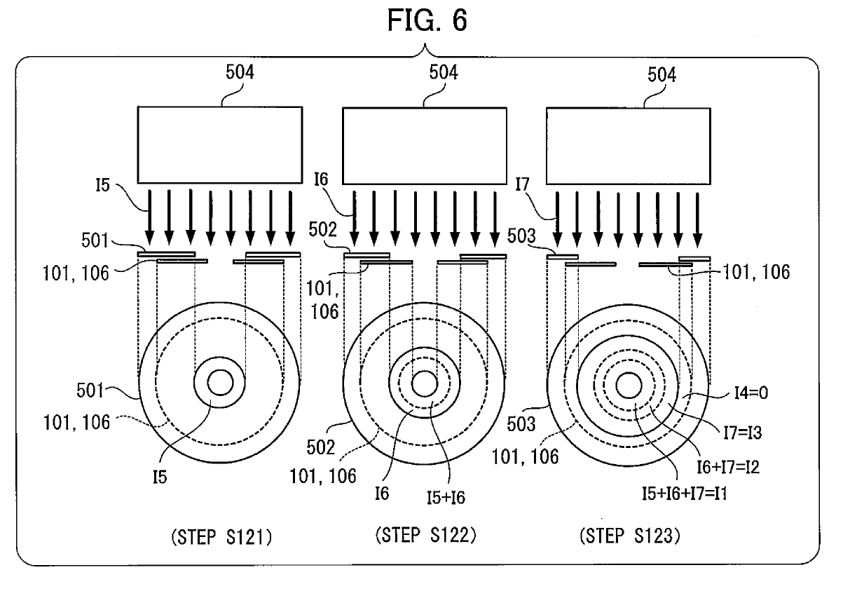

FIG. 6 is a detailed drawing of the processing of ion implantation using argon ion.

In the processing of ion implantation with argon ion as illustrated in FIG. 6, three types of masks 501, 502, and 503 each having an opening in different size are used. These masks are formed of a material that blocks argon ion and have an opening in the center thereof. Namely, a first mask 501 with an opening whose inner diameter matches an outer diameter of the first area 100a of FIG. 4, a second mask 502 with an opening whose inner diameter matches an outer diameter of the second area 100b, and a third mask 503 with an opening whose inner diameter matches an outer diameter of the third area 100c are used. And in the step of ion implantation, the ion implantation is performed three times in total with argon ion by using these three types of masks 501, 502, and 503 respectively. In addition, these three times of ion implantations with argon ion are performed by using an ion source 504 of argon ion.

First of all, the ion implantation is performed with argon ion by using the first mask 501 (step S121). In this step S121, the first mask 501 is disposed right above the disc-shaped substrate 101 such that the center of the first mask 501 meets the center of the disc-shaped substrate 101. Then, from the ion source 504, argon ion is implanted into a portion of the magnetic film 106 corresponding to the first area 100a in FIG. 4 through the opening in the first mask 501, with an after-mentioned first implantation amount I5.

Next, the ion implantation is performed with argon ion by using the second mask 502 (step S122). In this step S122, through the opening in the second mask 502, argon ion is implanted in to a portion of the magnetic film 106 corresponding to the first area 100a and the second area 100b in FIG. 4, with an after-mentioned second implantation amount I6. As a result, in the portion corresponding to the first area 100a in FIG. 4, the implanting is performed with the ion implantation amount totaling the first implantation amount I5 and the second implantation amount I6, and in the portion corresponding to the second area 100b, the implanting is performed with the second implantation amount I6.

Finally, the ion implantation is performed with argon ion by using the third mask 503 (step S123). In this step S123, through the opening in the third mask 503, argon ion is implanted into a portion of the magnetic film 106 corresponding to the first area 100a to the third area 100c in FIG. 4 with an after-mentioned third implantation amount I7. As a result, in the portion corresponding to the first area 100a in FIG. 4, the implanting is performed with the ion implantation amount totaling the first implantation amount I5, the second implantation amount I6, and the third implantation amount I7. Also in the portion corresponding to the second area 100b, the implanting is performed with the ion implantation amount totaling the first implantation amount I5 and the second implantation amount I6, and in the portion corresponding to the third area 100c, the implanting is performed with the ion implantation amount of the third implantation amount I7.

Here, in this embodiment, the third implantation amount I7 is equal to the ion implantation amount I3 in the third area 100c in FIG. 4. That is, the third implantation amount I7 is the ion implantation amount I3 required to lower the magnetocrystalline anisotropy field Hk4 of the magnetic film 106 to the magnetocrystalline anisotropy field Hk3 in the third area 100c obtained in the graph G11 of FIG. 3.

Further, the second implantation amount I6 is determined as follows. The ion implantation amount I2 in the second area 100b of FIG. 4 is the amount obtained by adding the third implantation amount I7 (the ion implantation amount I3 in the third area 100c) to the second implantation amount I6. On the other hand, as described above, the second implantation amount I6 is also the ion implantation amount required to lower the magnetocrystalline anisotropy field Hk4 of the magnetic film 106 to the magnetocrystalline anisotropy field Hk3 and is a known value. Thereby, the second implantation amount I6 can be obtained by subtracting the third implantation amount I7 (the ion implantation amount I3 in the third area 100c) from the known ion implantation amount I2 in the second area 100b of FIG. 4.

Similarly, the first implantation amount I5 can be obtained by subtracting the third implantation amount I7 and the second implantation amount I6 from the known ion implantation amount I1 in the first area 100a of FIG. 4.

By the three times of ion implantations with argon ion, in the portion of the magnetic film 106 corresponding to the first area 100a in FIG. 4, argon ion is implanted with the ion implantation amount I1 that is enough to attain the magnetocrystalline an isotropy field HK1 of the first area 100a. And also in the portion of the magnetic film 106 corresponding to the second area 100b in FIG. 4, argon ion is implanted with the ion implantation amount I2 that is enough to attain the magnetocrystalline anisotropy field HK2 of the second area 100b, and in the portion of the magnetic film 106 corresponding to the third area 100c in FIG. 4, argon ion is implanted with the ion implantation amount I3 that is enough to attain the magnetocrystalline anisotropy field HK3 of the third are a 100c. Additionally, in the portion of the magnetic film 106 corresponding to the fourth area 100d in FIG. 4, the ion implantation with argon ion remains blocked until the end of the ion implantation step using argon ion, therefore, as described above, the ion implantation amount I4 in this portion stays at “0” and thus the magnetocrystalline anisotropy field originally held in the magnetic film 106, which is equal to the magnetocrystalline anisotropy field Hk4 is maintained as it is.

In this way, according to the step of ion implantation with argon ion in this embodiment, which uses three types of masks having openings of different size respectively, although the step itself is performed three times, the masks can be easily created to save preparations, thereby making the step of ion implantation perform easily.

From the above explanations, it is understood that an application mode that “the step of ion implantation is performed by implanting an ion to plural masks placed on the substrate one by one while replacing the plural masks, each mask having an opening of different size to block the ion at portions except the opening so that an amount of ion implantation is reduced from the inner circumference to the outer circumference” is preferable to the basic mode.

The step of ion implantation with argon ion illustrated in step S12 of FIG. 5 and FIG. 6 is an example of the step of ion implantation in this application mode.

After the step of ion implantation with argon ion illustrated in step S12 of FIG. 5 and FIG. 6 is finished, the formation of the dots 104 is performed (step S13). The processing in this step S13 is an example of forming a magnetization retainer in the basic mode.

In this step S13, firstly, on the magnetic film 106 after the ion implantation is performed with argon ion, a resist pattern for covering a portion to leave magnetization as the dots 104 is formed. Next, the ion implantation using argon ion is again performed over the resist pattern with an amount of the ion required to destroy magnetization in portions off the resist pattern. By the ion implantation using argon ion over the resist pattern, the portion covered by the resist pattern becomes the dots 104 and the portions off the resist pattern become the gap section 105 to fill in a gap between the dots 104. In this step S13, after the dots 104 are formed, a protection layer of diamond-like carbon is formed on its surface and the magnetic disk 100 of patterned media is completed.

The first manufacturing method of a magnetic disk illustrated in FIG. 5 is for producing the magnetic disk 100 explained by referring to FIGS. 1 to 4, of a simple type of magnetic disks without the zone structure.

Here, it is preferable to employ an application mode that “the step of forming plural magnetization retainers forms plural magnetization retainers each having a length in the circumferential direction such that the length becomes longer as closer to the outer circumference in all areas from the innermost circumference to the outermost circumference, and the step of ion implantation is performed in all areas from the innermost circumference to the outermost circumference such that an amount of the ion implantation becomes less as closer to the outer circumference” to the basic mode.

This application mode produces a simple type of magnetic disks that can record and reproduce information more easily without the zone structure, by suppressing the heterogeneity in the magnetization switching field. The processing of step S12 in the first manufacturing method of the magnetic disk illustrated in FIG. 5 corresponds to an example of the step of ion implantation in the application mode and the processing of step S13 corresponds to an example of the step of forming a magnetization retainer in this application mode.

According to the first manufacturing method of a magnetic disk, since argon ion that weakens the magnetocrystalline anisotropy is implanted in all areas from the inner to outer circumferences such that the amount of the ion is reduced in four levels, thereby obtaining the magnetic disk 100 of patterned media in FIG. 4, in which the heterogeneity in the magnetization switching field caused by the heterogeneous magnetic shape anisotropy among the dots is cancelled and the magnetization switching field is made uniform among the respective dots.

Next, a second manufacturing method of a magnetic disk to produce the magnetic disk 100 explained by referring to FIGS. 1 to 4 will be explained. This second manufacturing method of a magnetic disk corresponds to an embodiment of the manufacturing method of a magnetic recording medium.

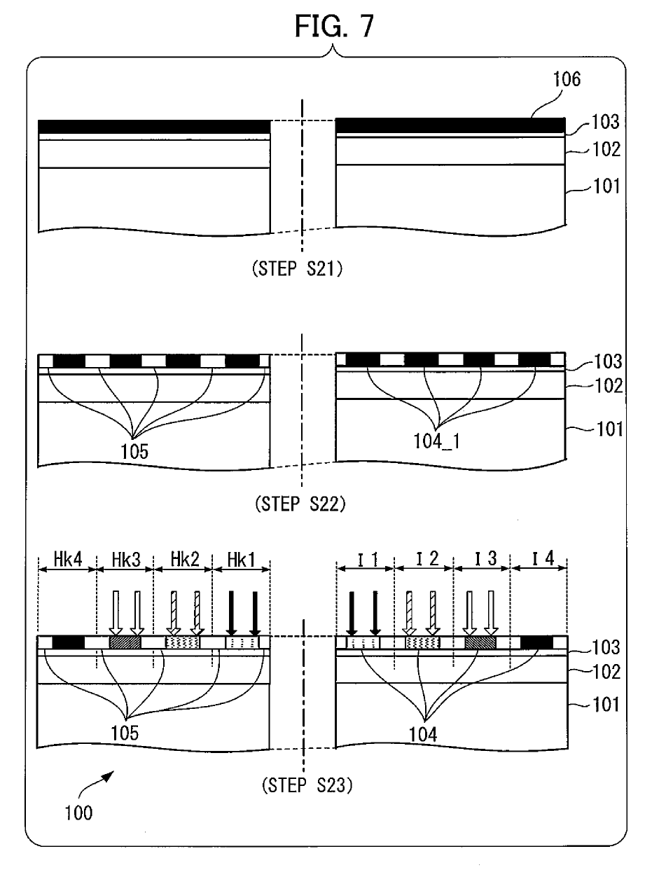

FIG. 7 illustrates a flow of the second manufacturing method of a magnetic disk to produce the magnetic disk 100 explained with reference to FIGS. 1 to 4.

This second manufacturing method of a magnetic disk in FIG. 7 is different from the first manufacturing method of a magnetic disk illustrated in FIG. 5 in that the order is changed between the step of ion implantation using argon ion and the step of forming the dots.

First, the same processing as in step S11 of FIG. 5 is performed to form a three-layered film composed of the backing layer 102, intermediate layer 103, and magnetic layer 106 on the disc-shaped substrate 101 of a nonmagnetic material (step S21). The processing in step S21 corresponds to an example of the step of forming a magnetic film in the basic mode.

Next, in the second manufacturing method of a magnetic disk of FIG. 7, the same processing as in the step of forming a dot illustrated in step S13 of FIG. 5 is performed to form the dots, the gap section 105, and the protective film or the like (step S22). However, the dots formed in this step S22 are different from the dots 104 of the finally produced magnetic disk 100, since the magnetocrystalline anisotropy field of all the dots formed in step S22 has been originally held in the magnetic film 106. Therefore, the dots formed in this step S22 of FIG. 7 are indicated with a mark “104_1”, which is different from the dots 104 of the disk 100. In this embodiment, the processing in this step S22 corresponds to an example of the step of forming a magnetization retainer both in the basic and application modes.

In the second manufacturing method of a magnetic disk in FIG. 7, in the end, the same processing as in the step of ion implantation (step S23) is performed with the four types of ion implantation amounts, I1, I2, I3, and I4, including the amount of “0”, as illustrated in step S12 of FIG. 5. However, in the second manufacturing method of a magnetic disk in FIG. 7, the step of ion implantation is performed to the magnetic film 106 in which the dots are already formed. By this, the magnetocrystalline anisotropy field of the dots 104_1 formed in the step S22 is lowered adequately and the magnetic disk 100 of patterned media provided with the four areas of 100a, 100b, 100c, and 100d each including the dots that internally incorporate the four types of magnetocrystalline anisotropy fields of Hk1, Hk2, Hk3, and Hk4 is completed. In this embodiment, the processing in the step S23 corresponds to an example of the step of ion implantation both in the basic and application modes.

Also by the second manufacturing method of a magnetic disk in FIG. 7, similarly as the first manufacturing method of a magnetic disk in FIG. 5, it is possible to obtain the magnetic disk of patterned media 100 of FIG. 4 in which the magnetization switching field is uniform among the respective dots.

Next, a second embodiment of the magnetic recording medium and the manufacturing method of the magnetic recording medium will be explained in contrast to the basic mode.

As similar to the first embodiment, also in this second embodiment, explanations will be made for the magnetic disk of patterned media as an embodiment of the magnetic recording medium and two types of the magnetic disk manufacturing methods each as an embodiment of the magnetic recording medium manufacturing method.

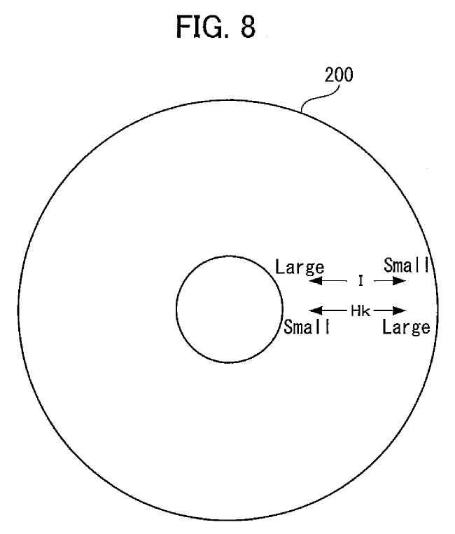

FIG. 8 is a drawing of a magnetic disk of patterned media as an embodiment of the magnetic recording medium.

Although in the magnetic disk 100 of the first embodiment illustrated in FIG. 4, the magnetocrystalline anisotropy of the dots 104 is increased in the four steps from the inner to outer circumferences, whereas in the magnetic disk of this embodiment illustrated in FIG. 8, the magnetocrystalline anisotropy is increased continuously from the inner to outer circumferences.

A magnetic disk 200 in FIG. 8 is a magnetic disk of patterned media similar to the magnetic disk 100 illustrated in FIGS. 1 and 4. However, the magnetocrystalline anisotropy Hk of the dots is increased continuously from the innermost track to the outermost track. In this embodiment, this continuous increase of the magnetocrystalline anisotropy Hk is realized, as described later, by the ion implantation in which the ion implantation amount I is gradually reduced as closer to outer circumference for a magnetic film having the default magnetocrystalline anisotropy field.

Here, in this embodiment, the change in the magnetocrystalline anisotropy field Hk from the innermost track to the outermost track is the change in the magnetocrystalline field represented by a portion associated with the variance of dot length from the innermost track to the outermost track, on the second line L12 in the graph G11 of FIG. 3. And the change in the ion implantation amount I from the innermost track to the outermost track is the change required to change the magnetocrystalline field.

Thereby, also in the magnetic disk 200 in this embodiment, in the same way as the magnetic disk 100 of FIG. 4, in all the areas from the innermost to outermost circumferences, the magnetization switching field of the dots becomes almost uniform at “10 kOe (795.77 kA/m)” indicated by the third line L13 in the graph G11 of FIG. 3. Further, since change in the magnetocrystalline anisotropy is continuous in the magnetic disk 200 in this embodiment, uniformity of the magnetization switching field becomes higher than that of the magnetic disk 100 of FIG. 4.

As a result, also in the magnetic disk 200 in this embodiment, in the same way as the magnetic disk 100 of FIG. 4, information can be easily recorded with high accuracy by suppressing the generation of write errors. Furthermore, no restriction is imposed on a type of magnetic disks such as the magnetic disk 200 in shaping the dot itself or in selecting magnetic materials to form the dot, thereby allowing high flexibility in designing.

Additionally, a disc-shaped substrate and dots in the magnetic disk 200 in this embodiment will be illustrated in a drawing of illustrating an after-mentioned manufacturing method of the magnetic disk 200. In this embodiment, these magnetic disk and dots correspond to examples of the substrate and the magnetization retainer respectively in the basic embodiment.

Next, a first manufacturing method of a magnetic disk to produce the magnetic disk 200 that has been explained with reference to FIG. 8 will be explained. This first manufacturing method of a magnetic disk also corresponds to an embodiment of the manufacturing method of the magnetic recording medium.

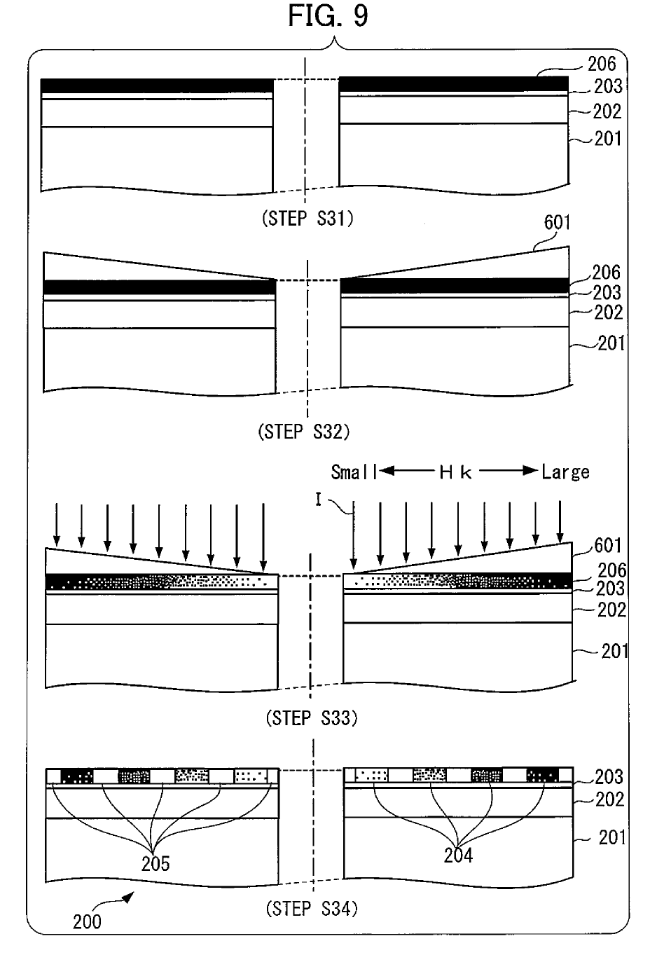

FIG. 9 illustrates a flow of the first manufacturing method of a magnetic disk to produce the magnetic disk 200 explained with reference to FIG. 8.

First, the same processing as in step S11 of FIG. 5 is performed, and a three-layered film composed of a backing layer 202, an intermediate layer 203, and a magnetic film 206 is formed (step S31). This step S31 corresponds to an example of the step of forming a magnetic film in the basic mode.

Next, on the magnetic film 206, a filer film 601 made of carbon that gains thickness from the inner to outer circumferences and blocks argon ion at a rate according to the thickness is formed (step S32). Here, the thickness of the filter film 601 increases from the inner to outer circumferences so that an amount of ion implantation using argon ion that is implanted into each portion of the magnetic film 206 through each portion of the filter film 601 is controlled to the amount required for changing the above-described magnetocrystalline anisotropy.

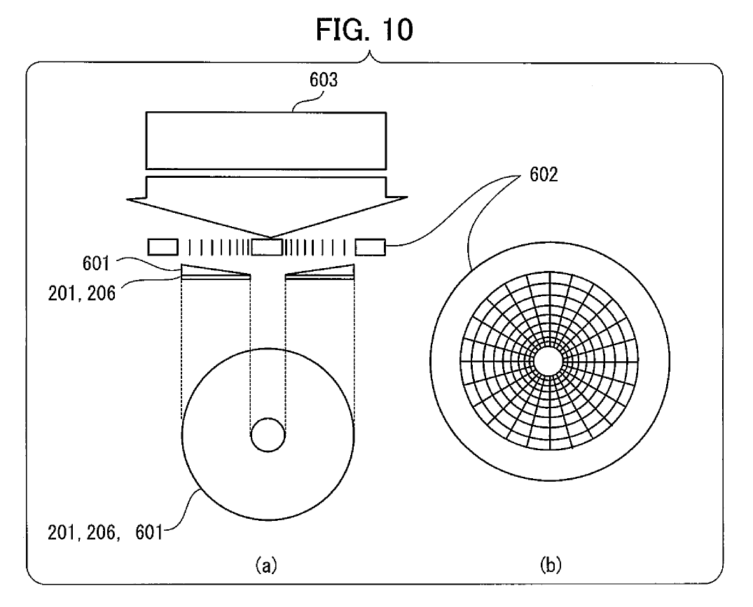

FIG. 10 illustrates a method of forming a filter film in step S32 of FIG. 9.

Part (a) of FIG. 10 illustrates a method of forming the filter film 601, and part (b) of FIG. 10 illustrates a top view of a collimator 602 (described later) used in this forming method.

This forming method of the filter film 601 forms a carbon film on the magnetic film 206 by the sputtering method. In this embodiment, the sputtering method is applied in a state where the after-mentioned collimator 602 is placed between a sputter source 603 of the carbon and the magnetic film 206.

The collimator 602 is a circular sieve with a lattice structure, having a diameter slightly larger than that of the disc-shaped substrate 201. The collimator 602 let through sputter particles traveling in depth direction of the lattice among the sputter particles which travel to the collimator 602. In this embodiment, a lattice interval in the lattice structure of the collimator 602 is widened gradually from the center of the collimator to its outer circumference.

Generally in collimators, it is easier for the sputter particles to pass through a wider lattice interval. Therefore, deposition speed of the sputter particles right below the collimators, that is, forming speed of the film becomes faster as the lattice interval becomes wider.

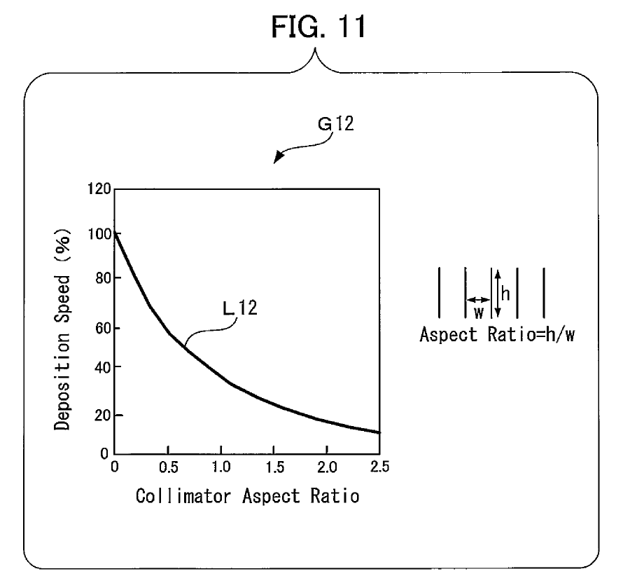

FIG. 11 is a graph indicating a relationship between a lattice interval and a deposition speed of sputter particles.

In the graph G12 of FIG. 11, its horizontal line represents collimator aspect ratio that is a ratio of lattice depth H to the lattice interval W, and its vertical line represents deposition speed of the sputter particles. Here, in the graph G12, the lattice depth H is constant, and as a result, on the horizontal line, a smaller collimator aspect ratio indicates a wider lattice interval W, whereas a larger collimator aspect ratio indicates a narrower lattice interval W.

The graph G12 illustrates the line L12 representing a relationship between the collimator aspect ratio and the deposition speed, i.e., the relationship between the lattice interval W and the deposition speed. As the line L12 represents, the wider the lattice interval W is, the more easily the sputter particles pass through the lattice interval, thereby making deposition speed faster. And the narrower the lattice interval W is, the less the sputter particles pass through the lattice interval, there by decreasing the deposition speed.

Here, the lattice interval of the collimator 602 in FIG. 10 used for forming the filter film 601 becomes wider from the center to the outer circumference thereof. As a result, at the time of forming the filter film 601, right under the collimator 602, the sputter particles are deposited faster as closer to the outer circumference. Thereby, in the sputtering method performed by placing the collimator 602 between the sputter source 603 of carbon and the magnetic film 206, the filter film 601 is formed such that the thickness of the film is increased as closer to the outer circumference of the disc-shaped substrate 201, as illustrated in FIGS. 9, 10.

Additionally, the thickness of the filter film 601 needs to be increased from the inner to outer circumferences, by controlling such that the amount of ion implantation with argon ion that is implanted into each portion of the magnetic film 206 through each portion of the filter film 601 corresponds to the implantation amount required to change the magnetocrystalline anisotropy. Therefore, in this embodiment, the lattice interval of the collimator 602 of FIG. 10 is widened from the inner to outer circumferences at a rate of realizing the increase in the thickness.

In the processing of step S32 in FIG. 9, as explained by referring to FIGS. 10, 11, after the filter film 601 is formed, the ion implantation with argon ion is performed on the filter film 601 (step S33). Here, in this embodiment, the ion implantation amount I with argon ion that is implanted over the filter film 601 is determined based on the thickness of the filter film 601 and the thickness of the magnetic film 206 such that the amount of the ion implantation after passing through the filter film 601 corresponds to the implantation amount required to change the magnetocrystalline anisotropy. By the ion implantation with argon ion through the filter film 601 in step S33, the magnetocrystalline anisotropy of the magnetic film 206 is continuously lowered from the inner to outer circumferences of the disc-shaped substrate 201.

Further, in step S33, after the ion implantation with argon ion, the filter film 601 is removed by reactive ion etching.

The processing of step S32 and step S33 together corresponds to an example of the step of ion implantation in the basic mode.

In this embodiment, by the ion implantation through the filter film 601, it is possible to reduce the magnetocrystalline anisotropy continuously from the inner to the outer circumferences of the disc-shaped substrate 201 easily.

This indicates that an application mode that “the step of implanting an ion further includes the step of forming a filter film to block an ion at a rate in accordance with a thickness of the filter film, by increasing the thickness of the filter film from the inner to the outer circumferences; the step of implanting an ion through the filter film; and the step of removing the filter film” is preferable to the base mode of the manufacturing method of the magnetic recording medium.

Here, the processing in step S32 of FIG. 9 corresponds to an example of the step of forming a filter film in this application mode, and the processing in step S33 corresponds to an example of the step of ion implantation and the step of removing the filter film in this application mode.

Further in this embodiment, the filter film 601 is formed of carbon that can be removed well by reactive ion etching. Since the etching rate of the carbon is higher than that of alloy containing cobalt and platinum forming the magnetic film 206, it is possible to effectively avoid damages to the magnetic film 206 at the time of removing the filter film 601 by the reactive ion etching.

This indicates that an application mode that “the step of forming a filter film forms the filter film with a material of which etching rate is higher than that of the magnetic material; and the step of removing the filter film removes the filter film by etching” is preferable to a type of the application mode in which the ion implantation is performed through the above-described filter film.

Here, the processing in step S32 of FIG. 9 corresponds to an example of the step of forming a filter film in this application mode and the processing in step S33 also corresponds to an example of the step of removing the filter film in this application mode.

Moreover, an application mode that “the step of forming a filter film forms the filter film with a material containing any one of carbon, tantalum, or silicon” is preferable to a type of the application mode in which the ion implantation is performed through the above-described filter film.

Either of carbon, tantalum, or silicon can be removed by etching and are known as materials having a high etching rate compared to the above-described magnetic materials.

In this embodiment, step S32 of FIG. 9 for forming the filter film 601 with carbon as described above corresponds to an example of this even preferable application mode.

After the processing in step S33 is completed, similar processing as in step S13 of FIG. 5 is performed to form dots 204 and a protection layer or the like and thus the magnetic disk 200 of patterned media is completed (step S34).

According to the first manufacturing method of a magnetic disk in FIG. 9, by implanting argon ion to weaken anisotropy such that the amount of ion is reduced gradually from the inner to outer circumferences, it is possible to obtain the magnetic disk 200 of patterned media in which the magnetization switching field caused by heterogeneous magnetic shape anisotropy between respective dots is cancelled and a uniform magnetization switching field is realized between the respective dots.

Next, a second manufacturing method of a magnetic disk to produce the magnetic disk 200 explained with reference to FIG. 8 is described. This second manufacturing method of a magnetic disk also corresponds to an embodiment of the manufacturing method of a magnetic recording medium.

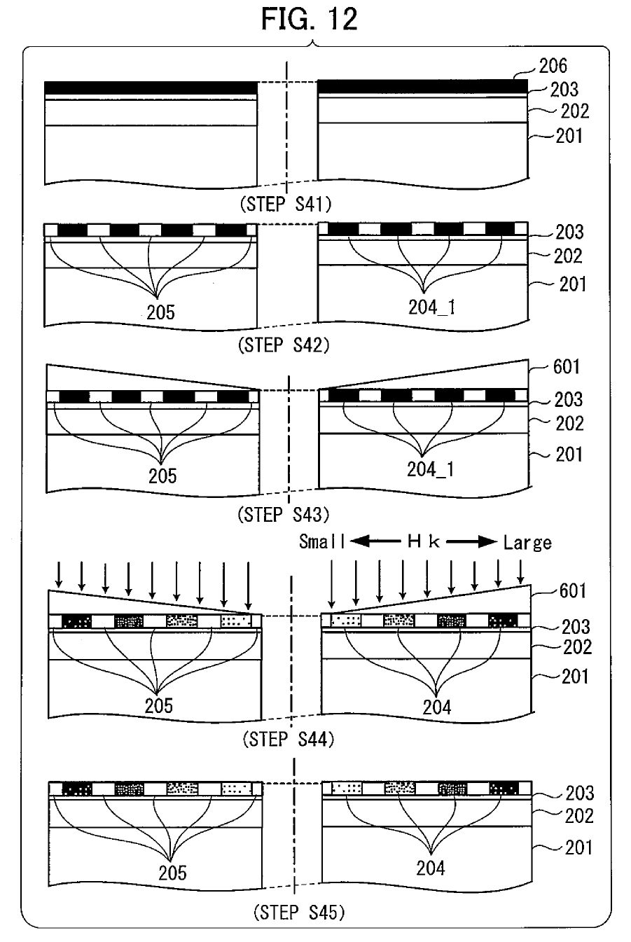

FIG. 12 illustrates a flow of the second manufacturing method of a magnetic disk to produce the magnetic disk 200 explained with reference to FIG. 8.

The second manufacturing method of a magnetic disk in FIG. 12 is different from the first manufacturing method of a magnetic disk in FIG. 9 in that the order of the processing from the step of forming the filter film 206 until the step of ion implantation with argon ion is replaced by the step of forming the dots.

First, the same processing as in step S31 of FIG. 9 is performed to form a three-layered film composed of a backing layer 202, an intermediate layer 203, and a magnetic layer 206 on a disc-shaped substrate 201 made of a nonmagnetic material (step S41). This step S41 corresponds to an example of forming a magnetic film in the basic mode.

Next, in the second manufacturing method of the magnetic disk in FIG. 12, the same processing as in the step of forming a dot illustrated in step S34 of FIG. 9 is performed to form dots, a gap section 205, and a protective film or the like (step S42). However, the dots formed in this step S42 are different from the dots 204 of the finally produced magnetic disk 200, since the magnetocrystalline anisotropy field of all the dots formed in step S42 has been originally retained in the magnetic film 206. Therefore, the dots formed in this step S22 of FIG. 12 are indicated with a mark “204_1”, which is different from the dots 204 of the disk 200. In this embodiment, the processing in this step S42 corresponds to an example of the step of forming a magnetization retainer both in the basic and application modes.

In the second manufacturing method of a magnetic disk in FIG. 12, after the processing of forming a dot in step S42, the same processing (step S43) as in the step of forming the filter film 601 in step S32 of FIG. 9 and the same processing (step S44) as in the step of ion implantation with argon ion in step S33 of FIG. 9 are performed in this order. When the processing in step S44 is finished, the plural dots 204 in which the magnetocrystalline anisotropy field Hk is continuously reduced from the inner to outer circumferences are obtained.

Finally, in the second manufacturing method of a magnetic disk in FIG. 12, the filter film 601 is removed by the reactive ion etching and the magnetic disk 200 of patterned media is completed (step S45). In this embodiment, a series of processing from step S43 to step S45 corresponds to an example of the step of ion implantation both in the basic and application modes.

Also by the second manufacturing method of a magnetic disk in FIG. 12, as similar to the first manufacturing method of a magnetic disk in FIG. 9, it is possible to obtain the magnetic disk 200 of patterned media in which the magnetization switching field is uniform among the respective dots.

Accordingly, in the above description, as one embodiment of the magnetic recording medium, the magnetic disk 100, 200 of patterned medium in which the length in the circumferential direction becomes longer as closer to the outer circumference in all areas ranging from the innermost to outermost circumferences, and furthermore, the amount of ion implantation in the dots becomes less in a stepwise manner or continuously in all the areas from the internal to outer circumferences is exemplified. However, the magnetic recording medium is not limited to this. For example, the magnetic recording medium may have the zone structure such that the length in the circumferential direction becomes longer as closer to the outer circumference in each zone and the amount of ion implantation becomes smaller in the stepwise manner or continuously in each zone from the innermost to outermost circumferences.

In the above description, as one embodiment of the magnetic recording medium, the magnetic disk 100 of patterned media in which the amount of ion implantation in the dots is reduced in four levels from the internal to outer circumferences is exemplified. However, the magnetic recording medium is not limited to this, and may be the one in which the amount of ion implantation is reduced in any number of levels except the four levels.

In the above description, as one embodiment of the manufacturing method of a magnetic disk, the manufacturing method of a magnetic disk in which three types of masks are used to reduce the amount of ion implantation in the four levels from the inner to outer circumferences is exemplified. However, the manufacturing method of a magnetic disk is not limited to this, and may be the one that reduces the amount of ion implantation in any number of the levels including the four levels.

In the above description, as one embodiment of the manufacturing method of a magnetic disk, the manufacturing method of a magnetic disk in which the filter film of the ion having pressure of the film increased from inner to outer circumferences is used to reduce the amount of ion implantation successively in the dots from inner to outer circumferences is exemplified. However, the manufacturing method of a magnetic disk is not limited to this, and for example, may be the one that reduces the amount of ion implantation continuously in the dots from inner to outer circumferences by using a mask capable of changing its opening continuously, such as iris mechanism used for aperture and others in camera, and by gradually opening the opening of the mask to fill in the ion.

In the above description, as one embodiment of the magnetic disk and the manufacturing method of the magnetic disk, the embodiment in which the magnetization switching field of each dot becomes uniform under “10 kOe (795.77 kA/m)” is exemplified. However, the magnetic disk and the manufacturing method of the magnetic disk are not limited to this, and the embodiment may be the one in which the magnetization switching field becomes uniform under a value other than “10 kOe (795.77 kA/m)”.

In the above description, as an example of the magnetization retainer in both the basic and application modes, the dot formed of the alloy containing cobalt and platinum is exemplified. However, the magnetization retainer is not limited to this, and for example, may be formed as a multi-layered film or the like in which a film having cobalt as a main component and a film containing at least any one of gold, silver, platinum, or palladium are alternately laminated.

In the above description, as one embodiment of the magnetic disk and the manufacturing method of the magnetic disk, the embodiment in which the resist pattern is formed having a shape corresponding to the alignment of the dots on the magnetic layer made of a magnetic material, and the ion implantation is performed over the resist pattern to destroy the magnetic shape anisotropy of a position off the resist pattern to form dots and the gap section that fills in a gap between the dots is exemplified. However, the magnetic disk and the manufacturing method of the magnetic disk are not limited to this, and the magnetic disk and the manufacturing method of the magnetic disk may employ, for example, an embodiment in which portions excluding the dots are physically removed from the magnetic layer made of a magnetic material by using ion milling or reactive ion etching or the like, and then the removed portions are filled with a non-magnetic material, thereby forming dots and the gap section that fills a gap between the dots.

In the above description, as an example of the ion implantation in both the basic and application modes, the ion implantation using argon ion is exemplified. However, the ion implantation is not limited to this, and for example, may be performed by using oxygen ion or nitrogen, or by using at least one type of ions selected among argon ion, oxygen ion, or nitrogen ion.

In the above description, as one embodiment of the manufacturing method of the magnetic recording medium, the embodiment in which the backing layer, intermediate layer, and magnetic film are formed on the disc-shaped substrate using the sputtering method is exemplified. However, the manufacturing method of the magnetic recording medium is not limited to this, and the backing layer, the intermediate layer, and the magnetic film may be formed on the disc-shaped substrate by using a vacuum evaporation method or a chemical vapor deposition method or the like.

Further, in the above description, as an example of the filter film in the application mode, the filter film formed of carbon is exemplified. However, the filter film in the application mode is not limited to this, and the filter film may be formed of, for example, tantalum, silicon, silicon oxide, silicon carbide, silicon nitride or the like.

Also, in the above description, as one embodiment of the manufacturing method of the magnetic recording medium, the embodiment in which the filter film is formed using the sputtering method is exemplified. However, the manufacturing method of the magnetic recording medium is not limited to this, and the filter film may be formed by using the vacuum evaporation method or the chemical vapor deposition method.

Additionally, in the above description, as an example of the magnetic retainer in both the basic and application modes, the dot having the shape that extends in the circumferential direction of the track is exemplified. However, the magnetic retainer is not limited to this, and the magnetic retainer may have the shape that corresponds to a skew angle of the magnetic head and extends in parallel with the magnetic head positioned right above the track.

The basic mode of the magnetic recording medium is a magnetic recording medium of patterned media in which the magnetization retainer is aligned on the substrate as a dot that is the smallest recording unit. In the basic mode of the magnetic recording medium, the length in the circumferential direction (dot length) of the magnetization retainer becomes longer as closer to the outer circumference. Therefore, a magnetization retainer has larger magnetic shape anisotropy as closer to the outer circumference. Here, in the basic mode of the magnetic recording medium, each magnetization retainer is subjected to ion implantation to weaken the magnetocrystalline anisotropy. Since an amount of the ion implantation declines from the inner to outer circumferences, the magnetization retainer holds larger magnetocrystalline anisotropy as closer to the outer circumference. Therefore, heterogeneity in the magnetization switching field caused by the heterogeneous magnetic shape anisotropy in the respective magnetization retainer is cancelled by differences in the magnetocrystalline anisotropy of the respective magnetization retainer, thereby suppressing the heterogeneity in the magnetization switching field. As a result, in the basic mode of the magnetic recording medium, magnetic switching for each magnetization retainer is made possible by a magnetic filed of the same intensity and recording of information can be easily performed with high accuracy while suppressing the generation of write errors. Additionally, in the basic mode of the magnetic recording medium, since the heterogeneity in the magnetization switching field is suppressed by applying the ion implantation to the respective magnetization retainers, there is no restriction in the shape of the magnetization retainer itself or in the selection of magnetic materials to form the magnetization retainer, thereby making a highly flexible design possible.

According to the basic mode of the manufacturing method of a magnetic recording medium, it is possible to obtain a magnetic recording medium in which the magnetization switching field is uniform among the respective dots, by applying the ion implantation to weaken the magnetocrystalline anisotropy such that an amount of the ion implantation is reduced as closer to the outer circumference, thereby canceling the heterogeneity in the magnetization switching field caused by the heterogeneous magnetic shape anisotropy among the respective dots. In sum, according to the basic mode of the manufacturing method of a magnetic recording medium, it is possible to manufacture the magnetic recording medium capable of recording information easily with high accuracy, allowing flexible design while suppressing the generation of write errors.

As explained above, according to the present embodiment, it is possible to obtain the magnetic recording medium of patterned media capable of recording information easily with high accuracy, allowing flexible design while suppressing the generation of write errors, and the manufacturing method of such magnetic recording media.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although this embodiment(s) of the present invention(s) has (have) been described in detail, it should be understood that the various changes, substitutions, and alterations could be made hereto without departing from the spirit and scope of the invention.

What is claimed is:

1. A magnetic recording medium comprising:
a disc-shaped substrate; and
a plurality of magnetization retainers arranged on the disc-shaped substrate in a plurality of circulations around a center of the substrate, each of the magnetization retainers having a length in a circumferential direction in such a manner that the length becomes longer as closer to outer circumference at least in a predetermined area, each retaining magnetization individually, each being formed of a magnetic material having axis of easy magnetization of magnetocrystalline anisotropy in a direction perpendicular to front and back surfaces of the substrate, each being implanted with an ion that weakens the magnetocrystalline anisotropy of the magnetic material in such a manner that an amount of ion implantation becomes less as closer to the outer circumference in the predetermined area.

2. The magnetic recording medium according to claim 1, wherein the length in the circumferential direction of the plurality of magnetization retainers becomes longer as closer to the outer circumference and the amount of the ion implantation becomes less as closer to the outer circumference in all areas from the innermost circumference to the outermost circumference.

3. The magnetic recording medium according to claim 1, wherein the magnetization retainers are implanted with at least one type of ions selected from argon ion, oxygen ion, or nitrogen ion as the ion.

4. The magnetic recording medium according to claim 1, wherein the magnetization retainers are formed of a magnetic material containing cobalt and platinum.

5. A manufacturing method of a magnetic recording medium, comprising:
forming on a disc-shaped substrate, a magnetic film made of a magnetic material and having axis of easy magnetization of magnetocrystalline anisotropy in a direction perpendicular to front and back surfaces of the disc-shaped substrate;
forming a plurality of magnetization retainers each retaining magnetization individually, each being arranged on the substrate in a plurality of circulations around a center of the substrate by leaving magnetization retained in the magnetic film locally while destroying magnetization in another portions, each having a length in a circumferential direction in such a manner that the length becomes longer as closer to outer circumference at least in a predetermined area; and
implanting an ion to weaken the magnetocrystalline anisotropy of the magnetic material with an amount of ion implantation that becomes less as closer to the outer circumference in the predetermined area, which is performed before or after the forming of magnetization retainers.

6. The manufacturing method of a magnetic recording medium according to claim 5, wherein the forming forms a plurality of magnetization retainers each having a length in the circumferential direction such that the length becomes longer as closer to the outer circumference in all areas from the innermost circumference to the outermost circumference; and
the implanting is performed in all areas from the innermost circumference to the outermost circumference such that an amount of the ion implantation becomes less as closer to the outer circumference.

7. The manufacturing method of a magnetic recording medium according to claim 5, wherein the implanting is performed by implanting an ion one by one with respect to a plurality of masks placed on the substrate while replacing the plurality of masks, each of the masks having an opening of different size to block the ion at portions except the opening so that an amount of ion implantation is reduced from the inner circumference to the outer circumference.

8. The manufacturing method of a magnetic recording medium according to claim 5, wherein the implanting further comprises:
forming a filter film to block an ion at a rate in accordance with a thickness of the filter film, by increasing the thickness of the filter film from the inner circumference to the outer circumference;
implanting the ion through the filter film; and
removing the filter film.

9. The manufacturing method of a magnetic recording medium according to claim 8, wherein the forming of a filter film forms the filter film with a material of which etching rate is higher than that of the magnetic material; and
the removing removes the filter film by etching.

10. The manufacturing method of a magnetic recording medium according to claim 8, wherein the forming of a filter film forms the filter film with a material containing any one of carbon, tantalum, or silicon.
